(19) United States
(12) Patent Application Publication
(10) Pub. No.: US 2014/0317146 A1
(43) Pub. Date: Oct. 23, 2014

(54) Method and system for the construction and management of complex ecosystem relationship models using a defined bidirectional entity relationship vocabulary for a multidimensional relationship data store

(71) Applicants: Jack L. Perkins, Provo, UT (US); Bruce E. Brown, Orem, UT (US); Ronald A. Maines, Alpine, UT (US); Joel V. White, Provo, UT (US)

(72) Inventors: Jack L. Perkins, Provo, UT (US); Bruce E. Brown, Orem, UT (US); Ronald A. Maines, Alpine, UT (US); Joel V. White, Provo, UT (US)

(73) Assignee: XANAMEDIA, Inc., Provo, UT (US)

(21) Appl. No.: 13/744,280

(22) Filed: Jan. 17, 2013

Related U.S. Application Data
(60) Provisional application No. 61/587,908, filed on Jan. 18, 2012.

(51) Int. Cl. G06F 17/30

(52) U.S. Cl. CPC G06F 17/30604
USPC 707/790

(57) ABSTRACT

A method and system for the computerized construction and management of complex ecosystem relationship models that can be viewed as graph databases. The system uses a well-defined and constrained entity and relationship vocabulary with bidirectional entity relationships. Relationships are further constrained so that there is a set of allowed relationships between classes of entities. Combining of ecosystem models can be accomplished by the merging of the common entities in each ecosystem while maintaining their existing relationships to other entities. Additionally, process orchestration can be dynamic by querying the entities and relationship properties to control the steps of the workflow.

### CROSS-REFERENCE TO RELATED APPLICATIONS

This application claims priority based on co-pending U.S. Provisional Application Ser. No. 61/587,908 filed Jan. 18, 2012, the disclosure of which is incorporated herein by reference.

### FIELD OF THE INVENTION

This invention relates to improved methods and systems concerning the design, implementation and deployment of data models that more fully reflect real world relationships while hiding much of the complexity of the lower level database design.

### BACKGROUND OF THE INVENTION

Entity relationship modeling has been used since A. P. G. Brown, and P. P. Chen each published papers describing such systems in 1976. An entity is a thing that can be uniquely identified, which is usually a noun. A relationship captures how two or more entities relate, which is usually a verb. The relationship in the traditional entity relationship model, expressed as a verb, has an implied directionality. A song entity and an artist entity are related by a “performs” relationship. The direction implied is the artist performs the song, not the song performs the artist. The goal of modeling entities and relationships was to help take real world objects (songs, artist), relationships (artist “performs” a song), and implement them in relational and other databases that had been developed in the early 1960s and later. This was the first step in the logical decomposition of entity relationships of the real world to database tables (rows and columns) representing the data in a computer. In current systems, complex data is functionally decomposed into units that are easily represented in the rows and columns contained in the tables of a relational database. There are no inherent relationships defined, however, between any of these elements. In order to provide the relationships necessary to process a transaction or to enable analysis of the data in context, a series of arbitrary connections or keys are created as pointers to linked records in the database. These record pointers, however, have no intrinsic meaning and simply provide an access mechanism for the convenience of the programmer. They often, in practice, bear no resemblance to the real-world, natural language description of the relationship being represented. By the time the real world data of entities and their relationship one to another is described by the tables in a relational database, much of the real world information and context has been lost. Users of such systems must have an intimate knowledge of the underlying database structure in order to be effective in the use such data stores.

### SUMMARY OF THE INVENTION

The invention starts by requiring that every relationship between entities be bi-directional. The artist performs the song and the song is performed by the artist. The entity relationship of the original implies that the artist performs the song. This is an implied directionality of the relationship. We can easily find all of the songs performed by the artist. If on the other hand we wish to find all of the artists that performed an individual song the query is not so simple when the data is implemented as unidirectional relationships in a relational database. By requiring bi-directionality it gives the process the ability to start a search at any point in the data model and find information by navigating the relationships. We can easily find the songs performed by each artist and we can with similar ease find all of the artists that performed the song. Each entity may have attributes and each relationship may also have attributes. The vocabulary for the relationships is constrained but expandable as is the list of entities. Specific applications can be constructed with limited sets of entities and relationships and then expanded at a later date without invalidating previous work. This inherent flexibility gives the method and system its uniqueness to model ecosystems. The invention requires that each entity to be modeled in the ecosystem be well-defined in an entity vocabulary list. Each relationship that can exist between entities in the model must be similarly well-defined in a relationship vocabulary list. A third is maintained by the data store which defines the allowed relationships between any two classes of entities in the ecosystem, thus constraining the data store to only accept relationships that exist in the ecosystem being modelled. For example, a “contains” relationship would not be defined as allowed between a Person object and a Car object; “John” would not be allowed to “contain” a “Volvo”. In a similar fashion to a relational database management system enforcing “referential integrity”, this feature of the invention enforces the “semantic integrity” of the multidimensional relationship data store.

Another feature is the ability to combine or merge ecosystem models. For example there could be a medical ecosystem modeled with persons who have the roles of doctors, nurses, patients, and administrators; then the clinic with beds, procedures performed, and supplies used. Another ecosystem modeled could be an education system with persons who have the role of teachers, guest lectures, students; then the classes offered. Combining the two models required only that we merge the persons. Questions can then be asked like “How many doctors gave guest lectures last year and who were the students who attended?”, “Who took this class for continuing medical education?”, or “Who taught this class?”

Workflow or orchestration processes depend upon someone programming the flow for each application. These workflows are static and when changes are needed, require re-programming. With this new way of modeling relationships we can also change the way that workflows are executed. A workflow becomes dynamic when it can query the attributes of the entities and relationships and change what needs to be performed. A static workflow might list all persons who can initiate the purchase with dollar amount limits for each. The workflow would then be programmed to view the data and after a purchase order was written, determine who must approve it. If on the other hand the workflow queried the entities, it could dynamically determine who must approve it and when changes in approval amounts happened, the workflow would not need to be reprogrammed; only the approval amounts in the data store.

### BRIEF DESCRIPTION OF THE FIGURES

FIG. 1. Traditional entity relationship diagram with implied directionality

FIG. 2. Multidimensional entity relationship diagram with bi-directionality

FIG. 3. Hospital example as traditional entity relationship

FIG. 4. Hospital example as multidimensional entity relationship

FIG. 5. Simple list of vocabulary for hospital example

FIG. 6. Education ecosystem model

FIG. 7. Combined Hospital and Education model

FIG. 8. Purchase order dynamic workflow

FIG. 9. Multidimensional relationship for a fictitious company

### DETAILED DESCRIPTION OF THE FIGURES

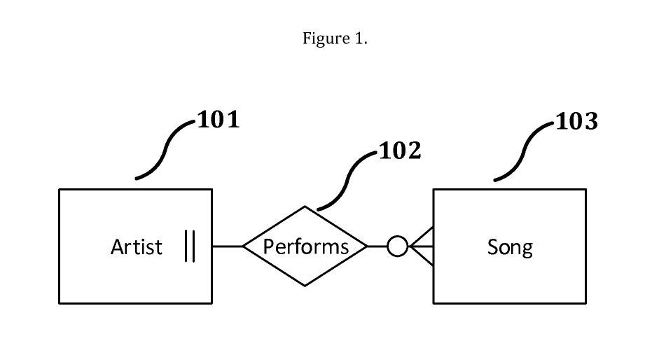

In FIG. 1. we show the traditional Chen entity relationship diagram of an artist performing a song. The artist 101 is an entity and the song 103 is an entity. The relationship 102, performs, infers directionality. The artist “performs” the song. The song does not perform the artist. There is a one to many relationships between the artist and songs. This diagram emphasizes that to find all of the artists who have performed a specific song would take an examination of every artist in the database.

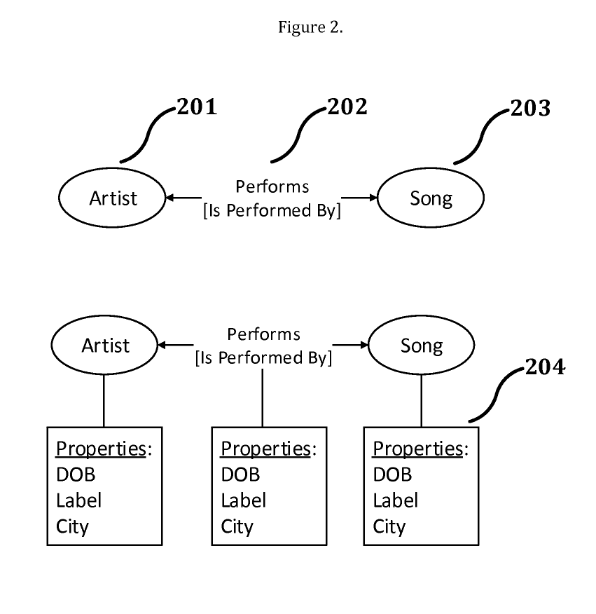

FIG. 2. shows the Perkins notation for multidimensional relationships. The entities are again the artist, 201, and the song 203. The bi-directional relationship, 202, is “performs” and “is performed by”. When implemented the song's relationship to the artist is bi-directional and finding all of the artists who performs a specific song only takes following the relationship back to all of the artists. Each of the entities and the relationships may have properties, 204, or in Chen's world attributes.

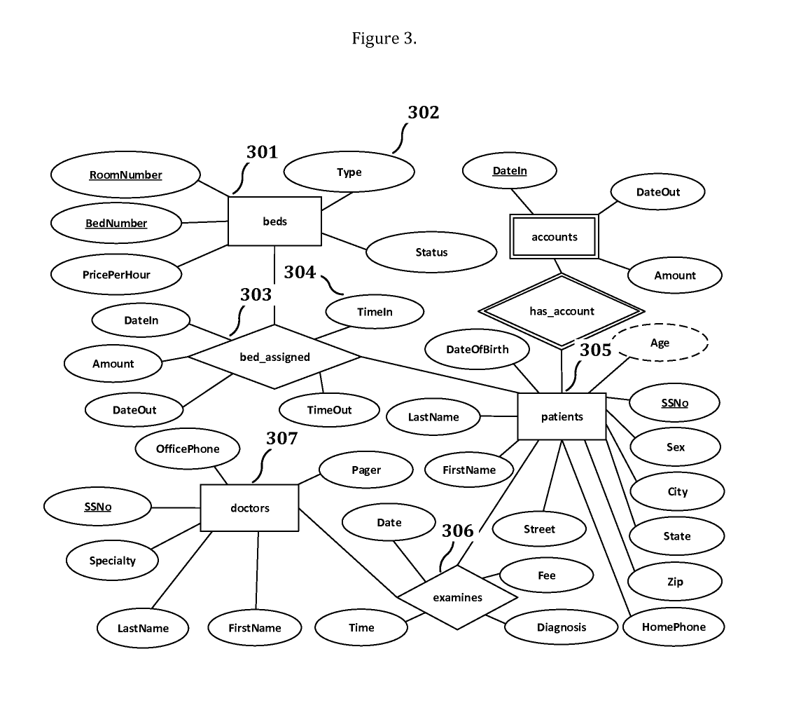

FIG. 3. shows both the traditional Chen entity relationship diagram with attributes and the Perkins multidimensional relationship diagram for a portion of a hospital or clinic ecosystem. The bed, 301 has attributes 302, and is assigned, with it's attributes 304, to a patient 305. The doctor 307 “examines” 306, the patient 305. The directionality is assumed. The doctor “examines” the patient. The patient “is assigned” a bed. This diagram and the resulting database works well for establishing an account and billing the patient. We know when the patient was assigned a bed from the attributes of the assigned relationship. We also know who the doctor examined. But if we were to ask the question “How many patients have used the bed in the last 30 days?” the database query is complex. We also can not directly ask the question “Who examined the patient?” without first querying all of the doctors in the database because of the inferred directionality of the data. In the Perkins multidimensional relationship diagram the bed, 310, has a bidirectional relationship with the patient, 309 so asking the question of how many patients used the bed is simple to compute.

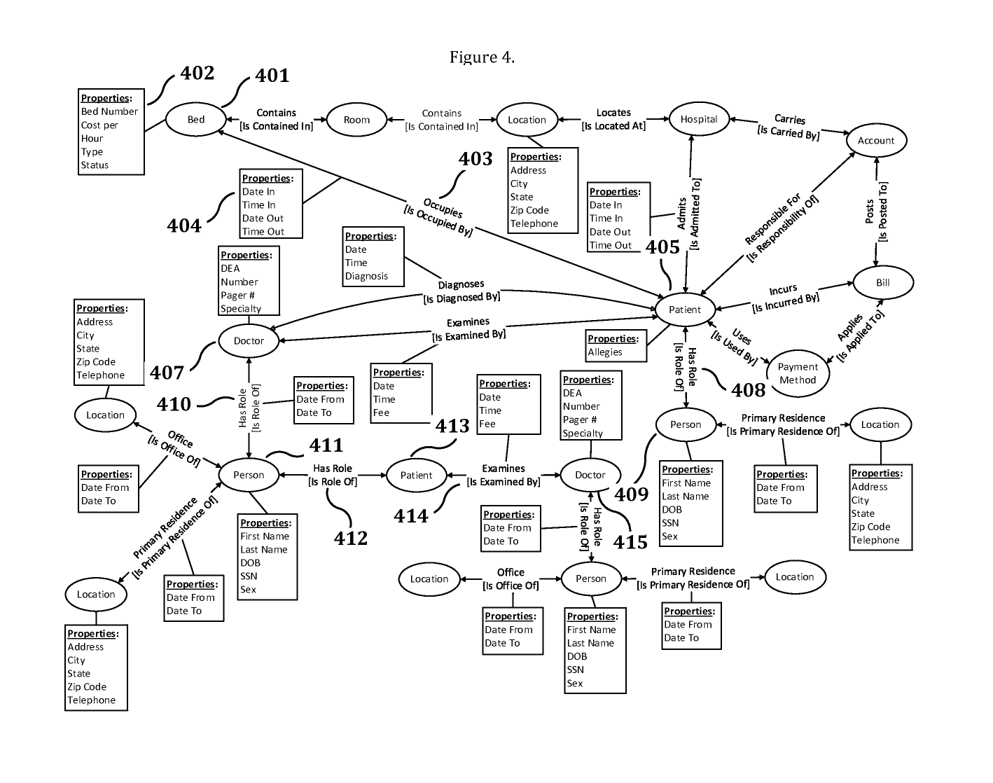

FIG. 4. shows an expanded Perkins multidimensional relationship diagram for a portion of a hospital ecosystem. In this diagram the bed 401, has properties 402, and is “occupied by” 403 relationship with properties 404, by the patient 405. We have added that the patient 405 “has role” 408, person 409. The patient 405 is “examined by” 406, a doctor 407, who is also a person 411 who is currently acting in the “role of” a doctor 407. This doctor 407, who is the person 411 also has a “role of” 412, patient 413. He, 411, “is examined by” 414, another doctor 415. By breaking out the doctor and patient as “roles of” persons we are able to add flexibility to the system and ask many questions that may not be thought of during the design of the data store.

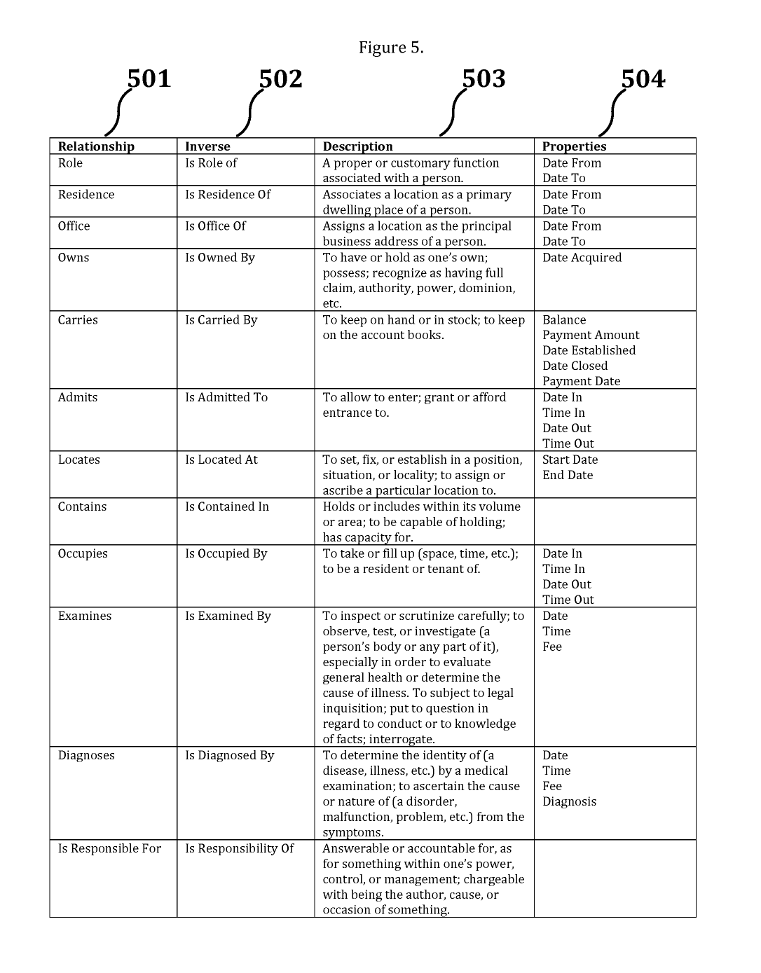

FIG. 5. shows a sample vocabulary for FIG. 4. The first column, 501, is the relationship. Column 2, 502, is the inverse relationship. In the multidimensional data store all relationships are required to have an inverse relationship. The third column, 503 is just a description of the relationship to help clarify it. This is only used by the system to explain the relationship. The properties, 504, are stored for each relationship and may be expanded anytime to bring more data into the system.

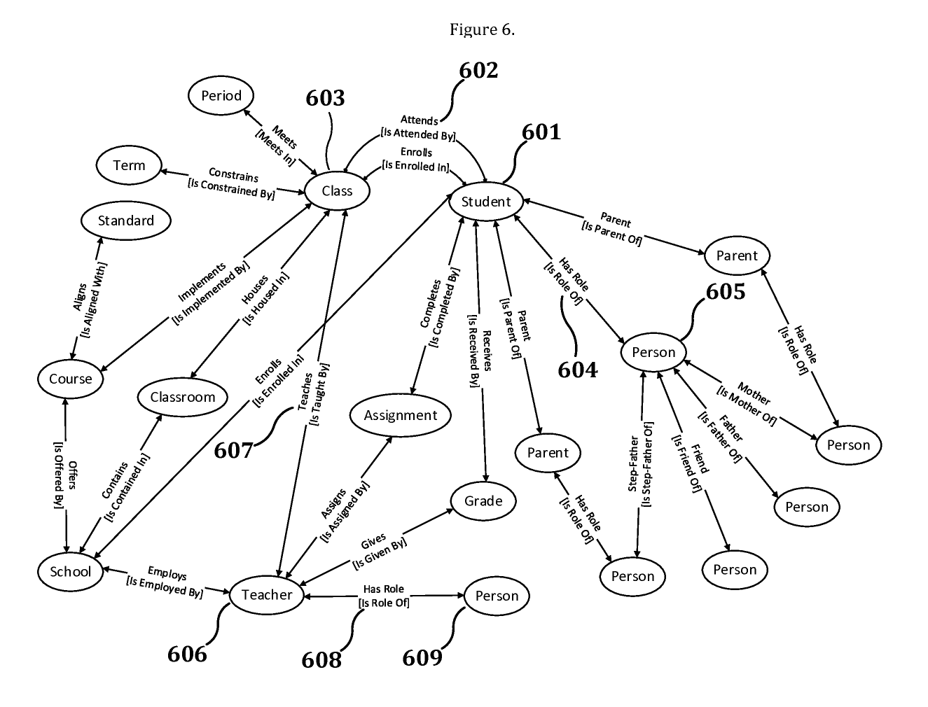

FIG. 6. shows the Perkins multidimensional relationship diagram for a simple education system ecosystem. The student 601 “attends” 602 the class 603. The student 601 “is role of” 604 for the person 605. The class 603 “is taught by” 607 a person 609 who “has role” of teacher 606.

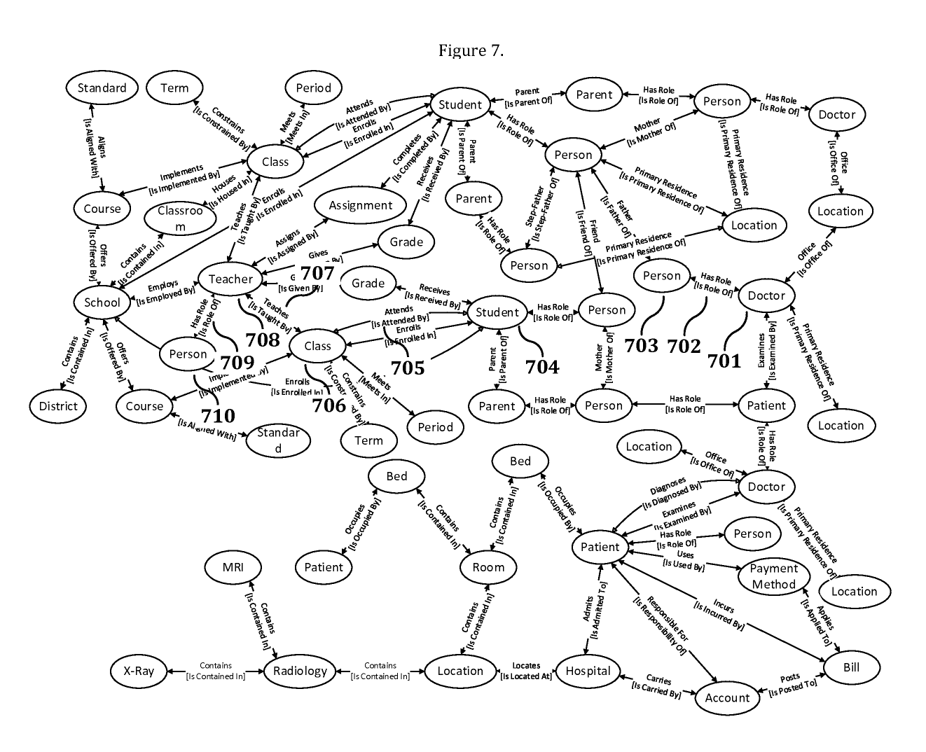

FIG. 7. shows the Perkins multidimensional relationship diagram for the combined hospital and education system ecosystems. By simply adding the persons from each set of relationships and eliminating duplicates we can merge these two ecosystems. We see that 701, the doctor, “has role” 702 of a person 703. The 704 student “attends” 705 the 706 class. The 706 class “is taught by” 708 the teacher 707 who is the person 710 acting is the “role of” 709 teacher 707. Questions can then be asked like “How many doctors (“role of”) gave guest lectures last year and who were the students (“role of”) who attended?”, “Who took this class for continuing medical education?”, or “Who taught this class?”

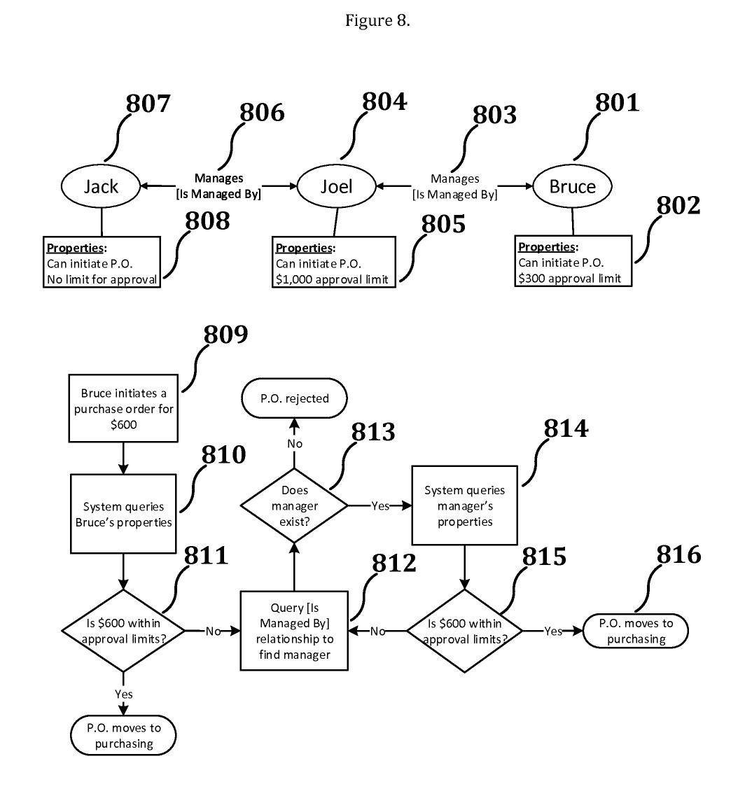

FIG. 8. shows the Perkins multidimensional relationship diagram of a business unit ecosystem. 801 Bruce has properties 802 and is “managed by” 803, 804 Joel with his properties 805. 804 Joel is “managed by” 806, 807 Jack with his properties 808. Storing this information allows us to create a dynamic workflow or orchestration that derives its steps as it goes along querying the data store. 801 Bruce initiates a purchase order 809 for $600 dollars. The orchestration begins by querying 810, Bruce's properties 802 for his signing limit. It finds 811, that 801 Bruce can only sign for $300 so it looks from 801 Bruce to find “is managed by” 802 to locate his manager in step 812. In 813 it finds that the manager 804 Joel does exist and 814 queries his properties 805 to find his signing limit. The question of is the $600 in his approval limits 815 is answered yes, 804 Joel is asked to approve and when his approval comes the purchase order moves on to 816 for purchasing.

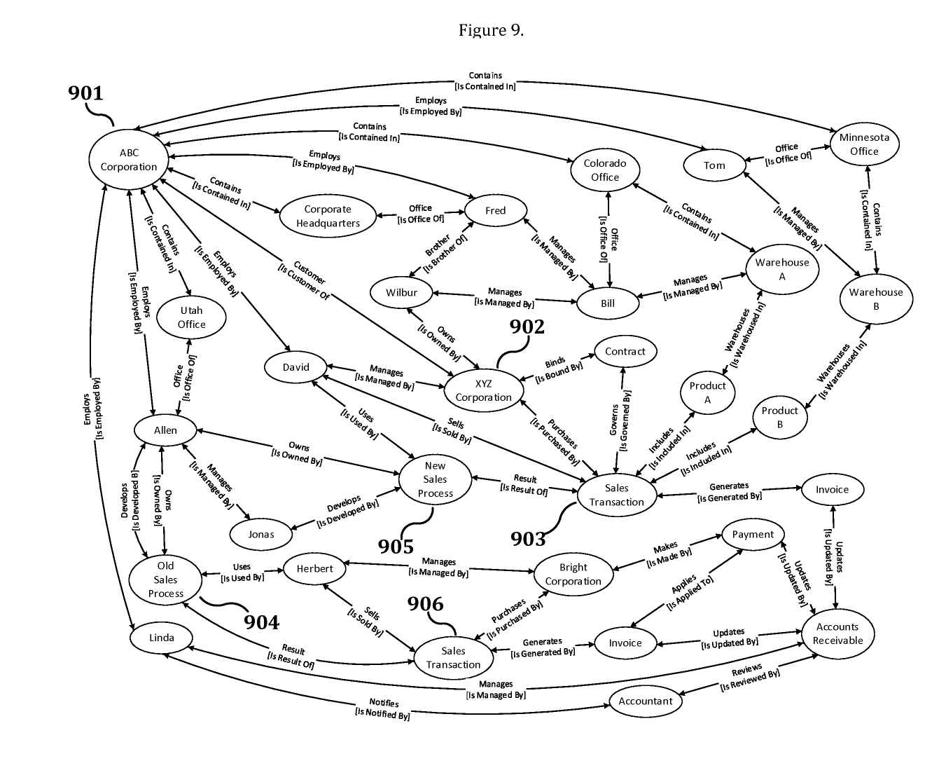

FIG. 9. shows the Perkins multidimensional relationship diagram of a fictitious company ABC 901. There is a customer 902 who transacts business 903 utilizing the 905 new sales process. Alternatively the 904 old sales process could have resulted in a 906 transaction. The purpose of this diagram is to show that various systems within the business ecosystem could be modeled and combined. It is now possible to ask the question “What orders came through the new sales process for a time period and what sales came through the old process?” In the traditional silo of data approach within a corporation the questions could not have been answered accurately. The sales transactions would have been recorded in an accounts receivable program. The corporation customers would be kept in a customer relationship management program and the workflow for a sale would have been programmed in a workflow server.

Although the present method and system has been described in considerable detail with reference to certain embodiments, other embodiments are possible within the scope of the invention. Therefore, the spirit or scope of the appended claims should not be limited to the description of the embodiments contained herein.

We claim:

1. A method of modeling real world relationships between entities comprising the steps of:
establishing a vocabulary defining the:
entities;
bidirectional relationships; and
the properties of each; and
establishing allowed relationships between the defined entities.

2. A method of claim 1 wherein new entities and relationships can be added to existing models.

3. A method of claim 1 dynamic workflow orchestration comprising the steps of:
starting with any entity;
querying its properties;
querying its relationships; and
executing the next step of the workflow based upon the results.

4. A method of combining models of real world relationships by merging the entities that are common.

5. A system of modeling real world relationships comprising the steps of:
establishing a vocabulary defining the:
entities;
bidirectional relationships; and
the properties of each; and
establishing allowed relationships.

6. A system of claim 5 wherein new entities and relationships can be added to existing models.

7. A system of claim 5 dynamic workflow orchestration comprising the steps of:
starting with any entity;
querying its properties;
querying its relationships; and
executing the next step of the workflow based upon the results.

8. A system of combining models of real world relationships by merging the entities that are common.
